(19) United States
(12) Patent Application Publication
(10) Pub. No.: US 2025/0391187 A1
(43) Pub. Date: Dec. 25, 2025

(54) RECOGNITION OF CONTENT OF DOCUMENTS HAVING FOLDS AND OTHER COMPLEX STRUCTURE

(71) Applicant: ABBYY Development Inc., Dover, DE (US)

(72) Inventors: Boris Zimka, Novi Sad (RS); Ivan Zagaynov, Dolgoprudniy (RU); Stepan Lobastov, Kirov (RU)

(21) Appl. No.: 18/752,566

(22) Filed: Jun. 24, 2024

(51) Int. Cl. G06V 30/12; G06V 30/148; G06V 30/19

(52) U.S. Cl. CPC G06V 30/12; G06V 30/15; G06V 30/19147; G06V 30/1916; G06V 30/19173

(57) ABSTRACT

Aspects and implementations provide for techniques of fast and efficient detection of depictions in multi-page documents and documents having complex structure. The disclosed techniques include processing an image of a document to generate probability distributions (PDs) predicting reference features (RFs) of the document. The model is trained using a first PD-to-RF mapping that samples RFs using training PDs generated for a training image. The techniques further include predicting the RFs using a second PD-to-RF mapping that determines the RFs based characteristics of the individual PDs. The techniques further include generating, using the predicted of RFs, a corrected image of the document, and extracting, using the corrected image, a content of the document.

### TECHNICAL FIELD

The implementations of the disclosure relate generally to computer systems and, more specifically, to systems and methods for extracting information contained in documents.

### BACKGROUND

Detection and recognition of textual and non-textual content of electronic documents is an important task in processing, storing, and referencing documents. Documents can be obtained using a variety of techniques including scanning, photographing, digital synthesis, and/or the like. Hand-held scanning functions are ubiquitous and available to most smartphone users via a variety of scanning applications. Optical character recognition (OCR) identifies texts (characters, words, phrases, etc.) from rasterized (pixelated) depictions of symbols by identifying reference symbols that most closely resemble symbols depicted in the documents and form words, sentences, and other units of texts of documents. Object recognition identifies non-textual objects, such as images, elements of graphics, logos, stamps, and other document content.

### SUMMARY OF THE DISCLOSURE

Implementations of the present disclosure are directed to fast and efficient techniques for identification of textual and non-textual document content using machine learning models.

In one implementation, a method of the disclosure includes processing, using a first model, an image of a document to generate a plurality of probability distributions (PDs), each PD of the plurality of PDs predicting a respective reference feature (RF) of a plurality of RFs of the document. The first model is trained using a first PD-to-RF mapping, the first PD-to-RF mapping sampling one or more RFs using a plurality of training PDs generated, using the first model, for a training image. The method further includes determining, using the plurality of PDs, the plurality of RFs. An individual PD of the plurality of PDs is determined using a second PD-to-RF mapping. The second PD-to-RF mapping determines a corresponding RF the plurality of RFs based on one or more characteristics of the individual PD. The method further includes generating, using the determined plurality of RFs, a corrected image of the document, wherein the corrected image corrects one or more distortions in the image of the document, and extracting, using the corrected image, a content of the document.

In another implementation, a method of the disclosure includes processing, using a first model, a training image of a document to generate a plurality of PDs, each PD of the plurality of PDs predicting a corresponding RF of a plurality of RFs of the document. The method further includes sampling, using the plurality of generated PDs, the plurality of RFs and computing, using a loss function, a loss value characterizing similarity of the plurality of sampled RFs to a plurality of ground truth RFs of the document. The loss function is invariant under a set of target permutations of the plurality of RFs. The method further includes modifying, based on the loss value, one or more parameters of the first model.

In yet another implementation, a system of the disclosure includes a memory and a processing device communicatively coupled to the memory. The processing device is to process, using a first model, an image of a document to generate a plurality of PDs, each PD of the plurality of PDs predicting a respective RF of a plurality of RFs of the document. The first model is trained using a first PD-to-RF mapping. The first PD-to-RF mapping samples one or more RFs using a plurality of training PDs generated, using the first model, for a training image. The processing device is further to determine, using the plurality of PDs, the plurality of RFs, wherein an individual PD of the plurality of PDs is determined using a second PD-to-RF mapping. The second PD-to-RF mapping determines a corresponding RF the plurality of RFs based on one or more characteristics of the individual PD. The processing device is further to generate, using the determined plurality of RFs, a corrected image of the document. The corrected image corrects one or more distortions in the image of the document. The processing device is further to extract, using the corrected image, a content of the document.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 is a block diagram of an example computer system supporting operations of an image processing pipeline for processing images of multi-page documents and/or documents having other complex structure, in accordance with some implementations of the present disclosure.

FIG. 2 illustrates data flow in an image processing pipeline that may be deployed for processing images of multi-page documents and/or documents having other complex structure, in accordance with some implementations of the present disclosure.

FIGS. 3A-3B illustrate schematically image padding performed as part of the image processing pipeline of FIG. 2, in accordance with some implementations of the present disclosure.

FIG. 4 illustrates one possible set of reference features for a two-page document with a fold, in accordance with some implementations of the present disclosure.

FIG. 5A illustrates schematically example operations of a reference feature prediction model that may be used for processing images of multi-page documents and/or documents having other complex structure, in accordance with some implementations of the present disclosure.

FIG. 5B illustrates various allowed permutations in joint detection of a set of reference features using multiple detection channels, in accordance with some implementations of the present disclosure.

FIG. 5C illustrates a permutation that is not acceptable, incurs a high cost during training, and is thus learnt to be avoided in training, in accordance with some implementations of the present disclosure.

FIG. 6A illustrated schematically an incorrect prediction of reference features of a document resulting from mixing of multiple reference features in an individual detection channel.

FIG. 6B illustrates schematically an improper detection corresponding to the permutation of FIG. 5C of reference feature channels disfavored in training of the reference feature prediction model.

FIG. 7 illustrates operations of a reference feature verification stage of processing images of multi-page documents and/or documents having other complex structure, in accordance with some implementations of the present disclosure.

FIG. 8 illustrates schematically projective transformations applied by a reference feature verification stage of processing images of multi-page documents and/or documents having other complex structure, in accordance with some implementations of the present disclosure.

FIG. 9 illustrates one example cropping of an uncorrected image for processing images of multi-page documents and/or documents having other complex structure, in accordance with some implementations of the present disclosure.

FIG. 10 illustrates schematically an example architecture of a backbone of a reference feature prediction model that may be used for processing images of multi-page documents and/or documents having other complex structure, in accordance with some implementations of the present disclosure.

FIG. 11 is a flow diagram illustrating an example method of using machine learning models for inference processing of multi-page documents and/or documents having other complex structure, in accordance with some implementations of the present disclosure.

FIG. 12 is a flow diagram illustrating an example method of training machine learning models for processing images of multi-page documents and/or documents having other complex structure, in accordance with some implementations of the present disclosure.

FIG. 13 depicts an example computer system that can perform any one or more of the methods described herein, in accordance with some implementations of the present disclosure.

### DETAILED DESCRIPTION

Public, corporate, governmental, legal, commercial, and other entities create and process billions of documents. Documents have a large variety of types, contents, formats, sizes, etc., and can be prepared using a multitude of sources, languages, styles, and/or the like. Documents include, e.g., passports, identification cards, forms, certificates, orders, receipts, invoices, etc., which may contain objects of various types, such as printed and/or handwritten words, phrases, numbers, tables, fields, checkboxes, signatures, seals, and/or the like. Many modern documents are created, used, modified, and stored in electronic forms, facilitated by the rise of powerful computing resources—including personal computing resources—that are becoming increasingly ubiquitous, deployed on desktop computers, smartphones, tablets, laptops and/or other similar devices.

Electronic documents have advantages over printed documents in terms of cost, transmission and distribution capabilities, ease of editing and modification, as well as storage simplicity and reliability. Nonetheless, paper documents remain in use and circulation today and cannot be fully replaced with electronic documents in the foreseeable future. In many countries, specific types of documents—e.g., passports, identification cards, legislative documents, foundational business documents, documents regulating activities of organizations, certain types of contracts, etc.—are mandated to be in paper or some other physical (e.g., plastic) form.

Printed (or other physical) documents often have to be translated into electronic form, e.g., by scanning and/or other imaging techniques. Portable scanners (including smartphone scanners) often produce images of documents that are of significantly lower quality than the images obtained with specialized equipment under favorable conditions (e.g., immobilization, controlled lighting conditions, sharp focus, correct alignment, etc.). Images acquired with inexpensive devices and/or under suboptimal conditions often have defects or other imperfections, such as perspective distortions, blur, out-of-focus, poor lighting, lack of contrast, uneven background, tilts/rotations, low resolution, cropped margins, and/or other imaging imperfections that make subsequent OCR and/or object detection difficult or computationally costly.

Factors important for quality and scalability of document processing techniques include completeness of capturing a document portion that contains relevant information, speed of document processing, applicability of the techniques to multiple types of documents, the ease of deploying the techniques on computing devices with different (including low) processing and/or memory resources, and the like. The existing techniques are often ineffective in processing images of documents that are misaligned (rotated, tilted) or have a complex structure, e.g., two (or more) pages, such as an open passport having the pages in a fold. Additionally, the pages are often imaged at different planes (e.g., an incompletely unfolded document), positioned at different distances from the camera/scanner, and/or subject to other distortions or imperfections (e.g., low-contrast background, a part of a document missing from the field of view, etc.), further complicating document processing and content extraction.

Aspects and implementations of the present disclosure address the above noted and other challenges of the existing document processing technology by providing for systems and techniques capable of processing single-page and multi-page documents having arbitrary alignment relative to the camera field-of-view and perspective distortions caused by incomplete unfolding. In some implementations, an incoming image of a document may be processed by a trained machine learning model that identifies multiple reference features within an image. For example, in the instances of a two-page document, reference features may include six corners of the document: the top-left corner, the top-right corner, the bottom-left corner, the bottom-right corner, the bottom corner of the fold, and the top corner of the fold. Each corner may be identified by a separate output channel of the model. More specifically, an output of an individual channel n may include a map of probabilities (heatmap) pₙ(x, y) indicative of the probability that nth reference feature is located at a pixel (or a group of pixels) associated with coordinates x, y of the image. The locations of the reference features may be computed as the expectation values \tilde{x}ₙ=Σ_{x,y}x·pₙ(x, y), y̅ₙ=Σ_{x,y}y·pₙ(x, y) or in some other way (e.g., as the location (xₘₐₓ, yₘₐₓ) of the maximum of the distribution pₙ(x, y), etc.). Since a multi-modal distribution pₙ(x, y) (with two or more maxima, e.g., resulting from multiple corners of a document detected by a single channel) can lead to an incorrect identification of the corresponding reference feature, the model may be trained to disfavor multi-modal distributions in a single channel. More specifically, during training, reference features may be randomly sampled from the output distributions pₙ(x, y) causing at least some reference features to be sampled from an incorrect (associated with a different reference feature) portion of the distribution pⱼ(x, y). Because such incorrect samplings incur a large cost (loss function) when compared with ground truth locations of reference features, the model learns to output single-maxima distributions. After the model learns to output single-maximum distributions, the outputs pₙ(x, y) of the deployed model can be processed by computing the expectation values of the locations of the reference features. This has an advantage of being more economical (in terms of computing costs), compared with probabilistic sampling, making the model capable of fast and efficient inference processing of large numbers of documents.

Further effectiveness of the model may be achieved by training the model to output the set of reference features jointly rather than forcing individual channels to detect a certain reference feature. More specifically, various permutations of the reference features among the output channels that preserve the topology of the detected document (e.g., up to reflections of the document) may be tolerated while permutations that violate the document topology are disfavored. Such tolerance may be achieved by using a loss function that assigns a low (or no) cost to various possible topology-preserving permutations while associating a larger cost with topology-breaking permutations.

Additionally, the model can resiliently operate under such unfavorable conditions where one or more reference features are not captured by the image, e.g., where one or more corners of the document fall outside the field-of-view of the camera. Such resilience may be achieved by padding the images—both in training and inference—with certain margins with pixels of some neutral background (e.g., fixed intensity or the average intensity and/or color of the image). As a result, the model learns to correctly predict locations of reference features even in the instances where these reference features are not explicitly captured by the image, based on the locations and appearance of other—visible—reference features.

After various reference features have been identified by the model, the geometry of the image may be corrected, e.g., by performing a number of projective transformations that transform multiple pages of the document to the same base plane (the image is flattened). Additionally, the image may be rotated to a default orientation based on the locations of the reference features. The corrected (flattened and rotated) image, having perspective distortions and misalignment corrected, may undergo any suitable computer vision processing, including but not limited to OCR, object detection, vision language model processing, and/or other content detection techniques.

In some implementations, a second trained reference feature classifier model may be used to analyze the suitability of the corrected image for content extraction, e.g., by evaluating the correctness of the determined reference features. In those instances where the reference feature classifier model determines that the reference features are determined correctly, the corrected image may be cropped compactly around the outline determined by the reference features. The cropped image may then be used for content detection/extraction. In those instances where the reference feature classifier model determines that the reference features are determined inaccurately, the corrected image may be discarded and the original image may be cropped, e.g., around the outline determined by the reference features. Finally, in those instances where the reference feature classifier model determines that the reference features in the corrected image are significantly misplaced or that the image is not of a type suitable for the multi-page processing, the corrected image may be directed for processing using some other computer vision techniques.

The advantages of the disclosed techniques include but are not limited to fast and resource-efficient detection of depictions of multi-page documents (and documents having other complex structure) in electronic images and correction of such depictions for more accurate content extraction.

As used herein, a “document” may refer to any collection of symbols, such as words, letters, numbers, glyphs, punctuation marks, barcodes, pictures, logos, etc., that are printed, typed, handwritten, stamped, signed, drawn, painted, and the like, on a paper or any other physical or digital medium from which the symbols may be captured and/or stored in a digital image. A “document” may represent a financial document, a legal document, a government form, a shipping label, a purchasing order, an invoice, a credit application, a patent document, a contract, a bill of sale, a bill of lading, a receipt, an accounting document, a commercial or governmental report, or any other suitable document that may have any content of interest to some user. A “document” may include any region, portion, partition, table, table element, etc., that is typed, written, drawn, stamped, painted, copied, and the like. A “document” may be generated using any suitable computing application and may include any computer-readable file that encodes any collection of symbols represented (among other things) via drawing instructions, e.g., any collection of commands, prompts, guidelines and/or the like that, alone or in conjunction with any application, compiler, rendered, and/or the like, inform a computing device how a specific symbol is to be represented on a computer screen, a printed media (e.g., paper), or any other media from which the symbol can be perceived by a human or by another computer. Examples of documents that may include such drawing instructions include (but are not limited to) documents in the Portable Document Format (PDF), DjVu format, electronic publication format (EPUB), Printer Command Language (PCL) format, or any other similar format.

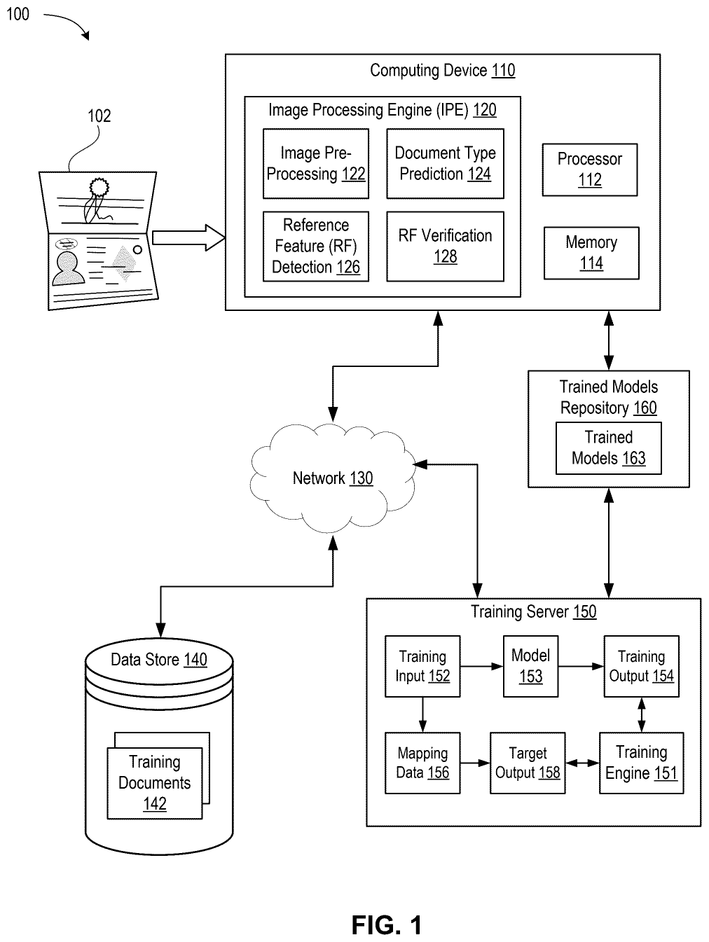

FIG. 1 is a block diagram of an example computer system 100 supporting operations of an image processing pipeline for processing images of multi-page documents and/or documents having other complex structure, in accordance with some implementations of the present disclosure. As illustrated, computer system 100 may include a computing device 110, a data store 140, and a training server 150 connected via a network 130. Network 130 may be a public network (e.g., the Internet), a private network (e.g., a local area network (LAN), wide area network (WAN)), and/or a combination thereof.

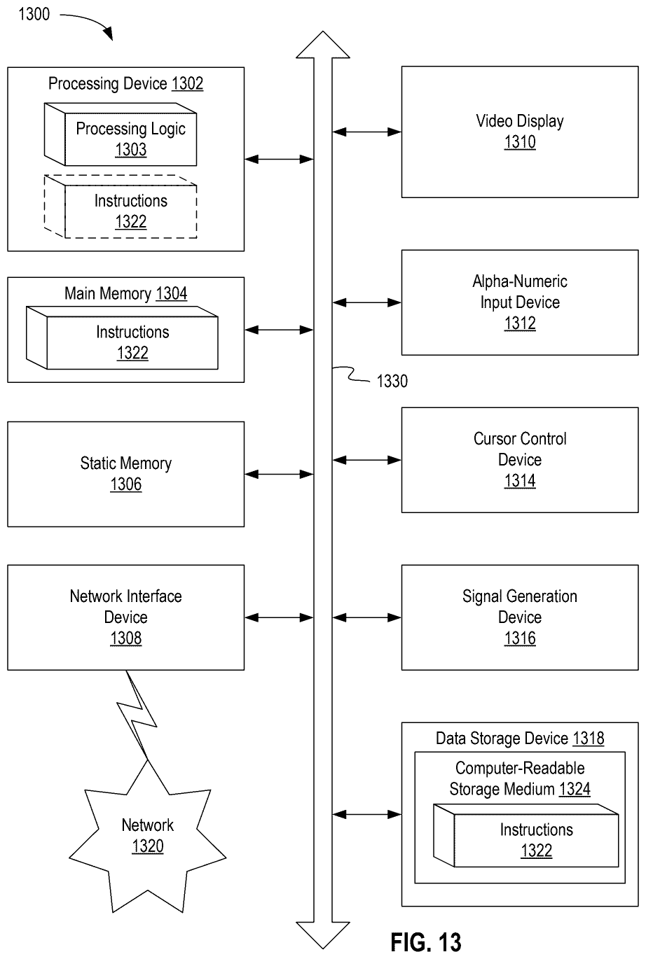

The computing device 110 may be a desktop computer, a laptop computer, a smartphone, a tablet computer, a server, a scanner, or any other suitable computing device capable of performing the techniques described herein. In some implementations, computing device 110 may be (and/or include) one or more computer systems 1300 of FIG. 13.

Computing device 110 may receive an image 102 depicting a document that may include text(s), graphics, table(s), and/or the like. Image 102 may be received in any suitable manner, e.g., locally or over network 130, and may be a letter (printed or electronic), an invoice, a purchasing order, a shipping form, a bill of lading, a government form, a financial form, an accounting form, or any other type of document. In those instances where computing device 110 is a server, a client device (not shown) connected to the server via network 130 may upload a digital copy of image 102 to the server. In the instances where computing device 110 is a client device connected to a server via network 130, computing device 110 may download image 102 from the server or from data store 140.

Image processing engine (IPE) 120 may identify types of the documents depicted in the images, detect locations and orientation of document depictions within image 102, correct document misalignment and perspective distortions of document content, and perform content detection/extraction, e.g., using OCR and/or other computer vision techniques, as according to techniques of the instant disclosure. In some implementations, IPE 120 may extract information from image 102 using multiple stages of processing. During a image preprocessing stage 122, IPE 120 may enhance (e.g., denoise, sharpen, etc.) image 102, normalize image 102 (e.g., resize, crop into patches, etc.), convert image 102 from black-and-white (B&W) format to color format or from color format to B&W format, and/or the like. In some implementations, IPE 120 may pad of image 102 with additional margins, for more accurate detection of corners/edges of depicted documents in the instances where one or more such corners/edges are located outside image 102. During a document type prediction stage 124, IPE 120 may process image 102 to determine whether the document depicted in image 102 is of a target type whose processing may benefit from the disclosed techniques, e.g., a multi-page document or a document with some other complex layout (rather than a simple one-page document that may be processed with other, e.g., less sophisticated, methods).

During a reference feature (RF) detection stage 126, IPE 120 may process image 102 to identify locations of various document reference features (RFs) that may be used for re-aligning image 102, cropping image 102, transforming and/or rescaling image 102, e.g., using one or more projective transformations, and/or performing any other image-correcting operations to improve suitability if image 102 for content detection. In some implementations, IPE 120 may further include an RF verification stage 128 to confirm that the corrected image belongs to the target type and may further determine whether the corrected image is suitable for further content extraction processing (e.g., determine whether the corrected image is an improvement over the original image of the document). The corrected image may then be used for processing by one or more OCR algorithms, object detection algorithms, or using any other computer vision techniques, presented on a suitable user interface of computing device 110, e.g., a monitor, display, screen, and/or the like, stored in memory 114 of computing device 110, communicated over network 130 (for storage and/or further processing), and/or used in any other applicable way.

Various components of IPE 120 may have access to instructions stored on one or more tangible, machine-readable storage media (e.g., memory 114) of computing device 110 and executable by one or more processors 112 of computing device 110. Processor(s) 112 may include one or more central processing units (CPUs), graphics processing units (GPUs), data processing units (DPUs), parallel processing units (PPUs), application-specific integrated circuits (ASICs), field-programmable gate arrays (FPGA), and/or any combination thereof. Processor(s) 112 supporting operations of IPE 120 may be communicatively coupled to one or more memory devices 114, including read-only memory (ROM), random access memory (RAM), flash memory, static memory, dynamic memory, and/or the like.

In some implementations, IPE 120 may be implemented as a client-based application or a combination of a client component and a server component. In some implementations, IPE 120 may be executed entirely on a client computing device, such as a desktop computer, a server computer, a tablet computer, a smart phone, a notebook computer, a camera, a video camera, or the like. Alternatively, some portion(s) of IPE 120 may be executed on the client computing device (which may receive image 102), e.g., image preprocessing stage 122, while other portion(s) of IPE 120, e.g., document type prediction stage 124, RF detection stage 126, and/or RF verification stage 128 may be executed on a server device. The server portion may then communicate results of object detection to the client computing device, which may allow a user of the client computing device to perform various operations with image 102, such as performing OCR on image 102, parsing image 102, printing image 102, copying portions of image 102, and/or the like. Alternatively, the server portion may provide the results of object detection to another application. In other implementations, IPE 120 may execute on a server device as an Internet-enabled application accessible via a browser interface. The server device may be represented by one or more computer systems, such as one or more server machines, rackmount servers, workstations, mainframe machines, personal computers (PCs), and so on.

A training server 150 may construct one or more models 153 to be deployed by IPE 120, including models of document type prediction stage 124, RF detection stage 126, and/or RF verification stage 128, and/or other modules of computing device 110 that content extraction from the images. Training server 150 may be and/or include a rackmount server, a router computer, a personal computer, a portable digital assistant, a mobile phone, a laptop computer, a tablet computer, a camera, a video camera, a netbook, a desktop computer, a media center, or any combination of the above. In some implementations, training may be performed by a training engine 151. In some implementations, training engine 151 may train models 153 that include neural networks having multiple neurons that perform classification tasks in accordance with various implementations of the present disclosure. Each neuron may receive its input from other neurons or from an external source and may produce an output by applying an activation function to the sum of weighted inputs and a trainable bias value. A neural network may include multiple neurons arranged in layers, including an input layer, one or more hidden layers, and an output layer. Neurons from different layers may be connected by weighted edges. In one illustrative example, all or some of the edge weights may be initially assigned random values.

Training of various models 153 may include using documents, for which ground truth has been identified (e.g., by a human expert or user), as training inputs 152 into the models 153 and changing parameters of the models in the direction that improves classification tasks performed by the models.

More specifically, training engine 151 may select one or more documents as training inputs 152 into a specific model 153 being trained and cause model 153 to generate a training output 154. Training engine 151 may compare training output 154 to a target (ground truth) output 158. Target output 158 may be mapped by mapping data 156 to the corresponding training input 152. In the instances of supervised training, mapping data 156 may include manual annotations of the documents depicted in training inputs 152. In some implementations, unsupervised (or self-supervised) training may be used, e.g., by embedding vectorized images of training documents (e.g., images in which locations of various features of the documents is known) into rasterized images using various projective transformations, which may be selected randomly or according to some programmed schedule. In such instances, mapping data 156 may include mapping of original (vectorized) images to transformed (rasterized) images of the training documents. During training, training engine 151 finds patterns in the correspondence of training inputs 152 to target outputs 158 and trains models 153 to capture such patterns.

Errors, e.g., differences between training outputs 154 and target outputs 158 may be propagated back through one or more neural layers of model 153, and the weights and biases of model 153 may be adjusted in the way that brings training outputs 154 closer to target outputs 158. This adjustment may be repeated until an error for a particular training input 152 satisfies a predetermined condition (e.g., falls below a predetermined error). Subsequently, a different training input 152 may be selected, a new training output 154 may be generated, and a new series of adjustments may be implemented, and so on, until the model is trained to a sufficient degree of accuracy or until the model reaches the limits determined by the model's architecture and complexity.

Various models 153 may include deep neural networks with one or more hidden layers, e.g., convolutional neural networks, recurrent neural networks (RNN), fully connected neural networks, neural networks with attention, transformer-based neural networks, or any combination thereof. The training data, including training inputs 152, target outputs 158, and mapping data 156, may be stored in data store 140. The patterns captured during training may be subsequently used by the models 153 for future object identification (classification) during the inference phase. In some implementations, some of the models 153 may include a template-based classifier, a rule-based classifier, a feature-based classifier, and/or some other suitable type of classifier.

Data store 140 may be a persistent storage capable of storing files as well as data structures to perform text recognition in electronic documents, in accordance with implementations of the present disclosure. Data store 140 may be hosted by one or more storage devices, such as main memory, magnetic or optical storage disks, tapes, or hard drives, network-attached storage (NAS), storage area network (SAN), and so forth. Although depicted as separate from the computing device 110, data store 140 may be part of computing device 110. In some implementations, data store 140 may be a network-attached file server, while in other implementations, data store 140 may be some other type of persistent storage, such as an object-oriented database, a relational database, and so forth, that may be hosted by a server machine or one or more different machines coupled via network 130. In some implementations, data store 140 may store one or more training documents 142. In some implementations, at least some of the training documents 142 may be stored on computing device 110 or training server 150.

Once one or more models 153 have been trained, the trained model(s) 163 may be stored in a trained models repository 160 (hosted by any suitable storage devices or a set of storage devices) and provided to IPE 120 of computing device 110 (and/or any other computing device) for inference analysis of new documents. For example, computing device 110 may process a new image 102 by determining whether the new image is of a target type, identifying RFs, correcting image 102 using the RFs, and extracting content of image from the corrected image. The extracted information may be used in any applicable way, including but not limited to further information processing, storing, printing, copying, communication, and so on.

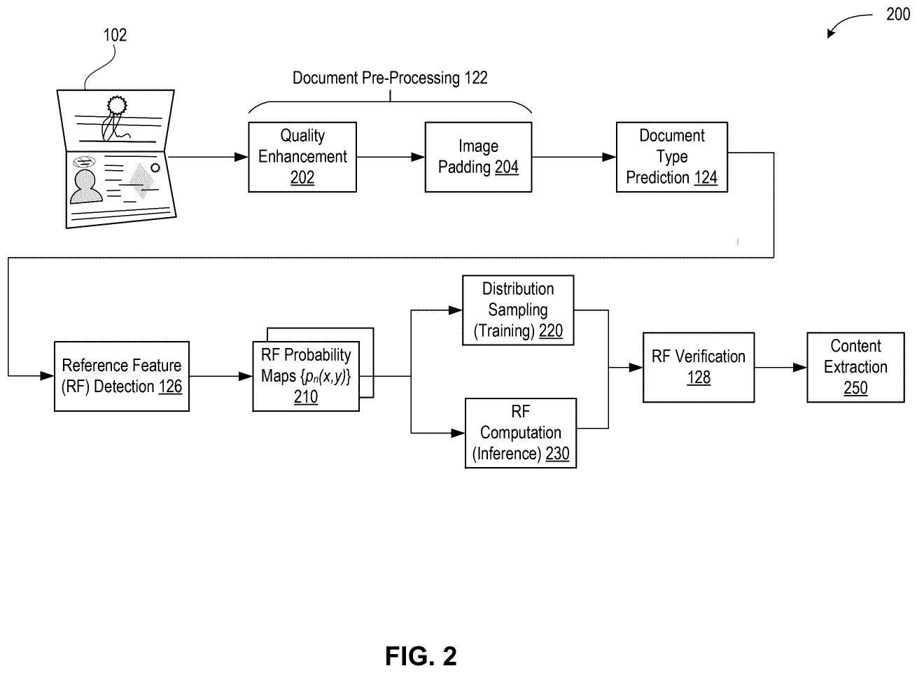

FIG. 2 illustrates data flow in an image processing pipeline 200 that may be deployed for processing images of multi-page documents and/or documents having other complex structure, in accordance with some implementations of the present disclosure. Operations of FIG. 2 may include receiving image 102. Image 102 may have a text content, e.g., typed text, handwritten text, etc. Text content of image 102 may be in any suitable human-readable (or machine-readable) form, including any written language and/or any set of alphanumeric symbols (e.g., letters, numerals, punctuation marks, etc.), glyphs, and/or other elements that are used to communicate lexical meaning in a written form. Image 102 may also have non-textual content, e.g., images, illustrations, elements of graphics, etc. Image 102 may also have a mixed content, e.g., content that includes elements of text and graphics, e.g., seals, stamps, logos, watermarks, pictures of text, text that is artistically drawn, and/or the like. Image 102 may also include any special content, e.g., signatures, barcodes, checkboxes, dividing lines, complex background, e.g., as may be found on passports, identification cards, certificates, etc. In some implementations, image 102 may depict a multi-page document, e.g., a passport, or any other foldable document. In some implementations, image 102 may depict a single-page document that has some complex layout, e.g., photographs, separation lines, multiple columns, tables, and/or any other suitable partitions.

Image preprocessing stage 122 of the image processing pipeline 200 may include operations of quality enhancement 202. Quality enhancement 202 may include denoising of image 102 (e.g., removing noise artifacts, including point artifacts, spot artifacts, line artifacts, and/or the like), deblurring image 102 (e.g., applying of one or more edge filters to sharpen contours of objects in image 102, and/or the like), adjusting brightness and/or contrast of image 102, and/or using any other suitable image enhancement techniques. In some implementations, image preprocessing stage 122 may include image padding 204. Image padding 204 may add margins around the perimeter of image 102. A size of the margins may be a certain (e.g., developer-set) percentage of the size of image 102, e.g., 3-7% of the size of image 102. For example, a 600×800 pixel image may be padded with left and right margins of 30 pixels each (5% of the width of the image) and the top and bottom margins of 40 pixels each (5% of the height of the image). In some implementations, the margins may include a fixed number of pixels independent of the size of image 102. The intensity of the added margins may be determined by averaging intensity map I(x, y) of image 102 from the full area of image 102 or from a certain portion of image 102 (e.g., an edge portion of the image), by using pixels of predetermined intensity (e.g., minimum or maximum intensity), and/or selected using some other technique.

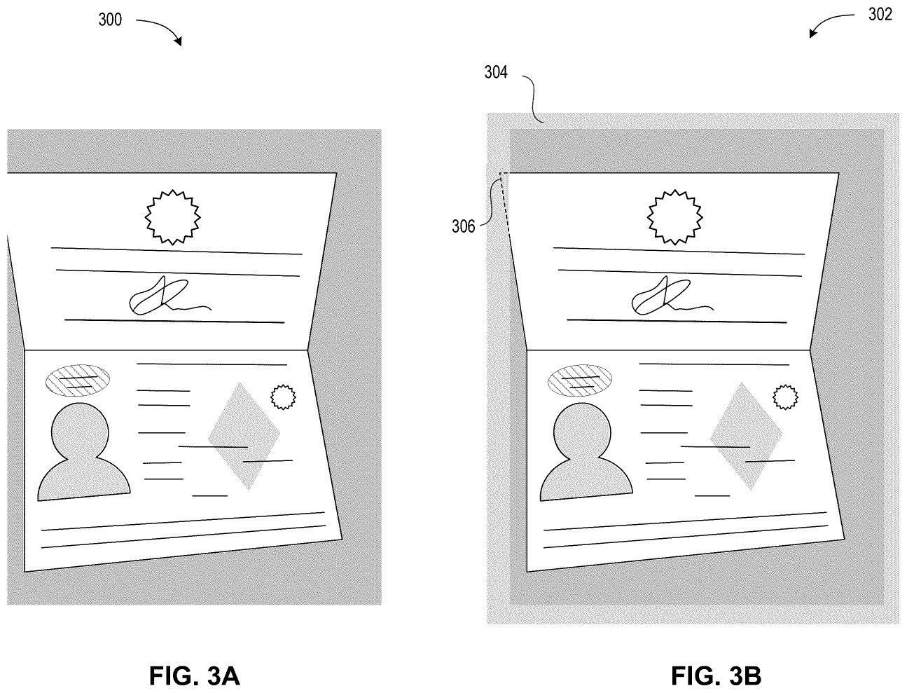

FIGS. 3A-3B illustrate schematically image padding 204 performed as part of the image processing pipeline 200 of FIG. 2, in accordance with some implementations of the present disclosure. FIG. 3A depicts an image 300 of a document whose top-left corner is outside the dimensions of the image. FIG. 3B depicts a padded image 302 with margins 304 added to improve the likelihood that the projected locations of the missing parts of the document, e.g., a projected top-left corner 306, are within the dimensions of the padded image 302.

Referring again to FIG. 2, document type prediction stage 124 may include a model that is trained to identify whether a document depicted in image 102 belongs to a target class, e.g., a two-page document with a fold, a document of a particular complex layout, and/or the like, or to a non-target class, e.g., a single-page document, a flat two-page document without a fold, and/or the like. The document type prediction model may be trained using multiple example target documents and non-target documents annotated with corresponding ground truth classes (e.g., “target” class and “non-target” class). In those instances, where image 102 is classified as a non-target document, further processing of image 102 by the image processing pipeline 200 may stop and image 102 may be processed using different techniques (e.g., a model trained to detect and/or correct orientation of images of single-page documents). In those instances, where image 102 is classified as a target document, processing of image 102 may continue with RF detection stage 126. Although document type prediction stage 124 is depicted as being performed after the image pre-processing 122, in other embodiments, document type prediction stage 124 may be performed before the image preprocessing stage 122, or before at least some portion of the image preprocessing stage 122. For example, document type prediction stage 124 may be performed after quality enhancement 202 (to improve the likelihood of correct type prediction) and before image padding 204.

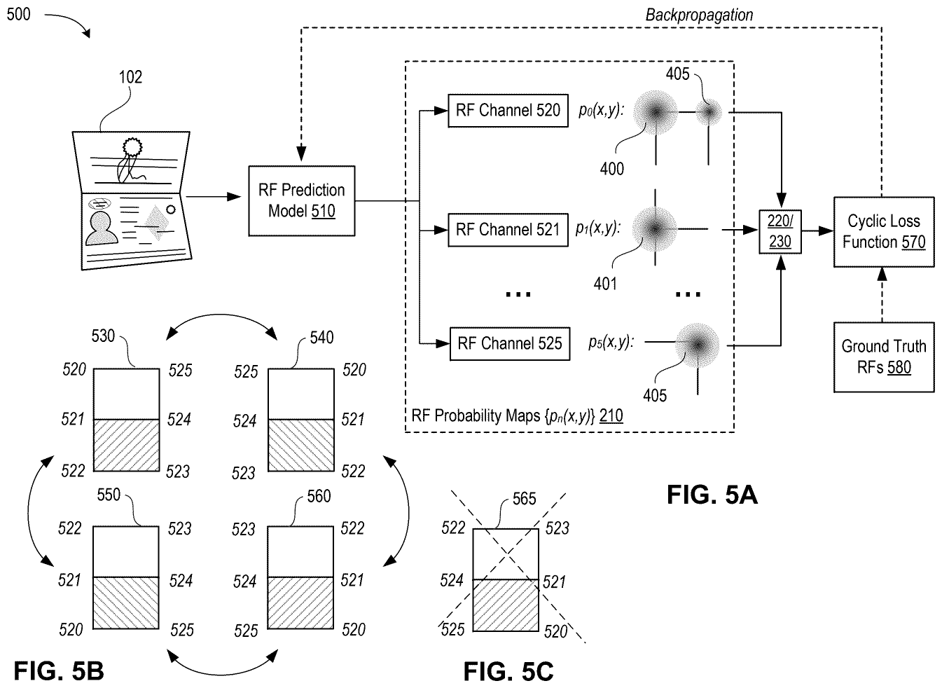

RF detection stage 126 may include an RF prediction model (e.g., RF prediction model 510 in FIG. 5) that uses an intensity map I(x, y) as an input and generates a set of multiple RF probability maps pₙ(x, y) 210:

$$I ( x , y ) \to RF prediction Model \to \{ {p}_{n} ( x , y ) \} .$$

The reference features may be or include any distinct characteristics or attributes of a document of the target type, e.g., corner points of the document, edges of the document, corner points of one or more tables, embedded or pasted images (e.g., photographs), watermarks, page numbers, dividing lines, folding lines, and/or any other characteristics or attributes that can be used for identification of orientation and visible dimensions of the document in image 102. The number of reference features may be sufficient to uniquely identify the orientation and dimensions of the document. For example, four corners may serve as reference features of a single-page document. Similarly, a depiction of a two-page document with both pages sharing the same folding line may be uniquely identified by six corner points: four corner points of a first page, with two points defining the folding line, and two additional corner points of the second page.

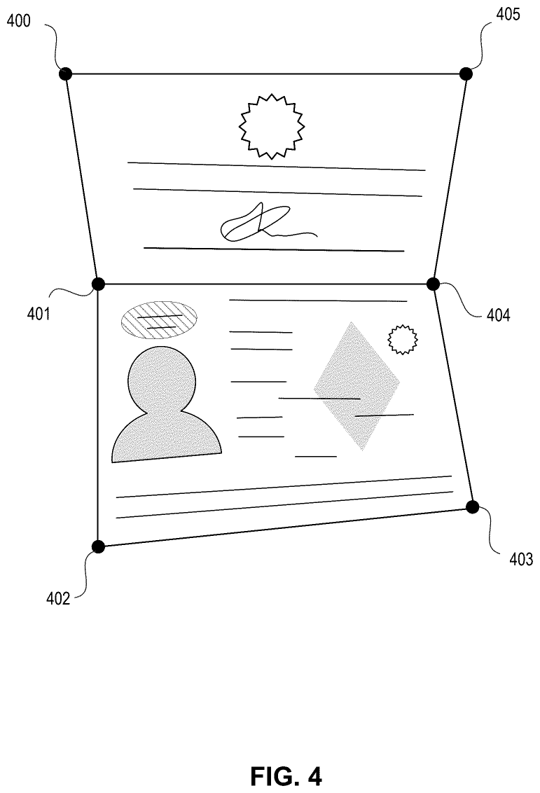

FIG. 4 illustrates one possible set of reference features for a two-page document with a fold, in accordance with some implementations of the present disclosure. The reference features of FIG. 4 include six corners: the top-left corner 400, the top-left corner 401 of the fold, the bottom-left corner 402, the bottom-right corner 403, the right corner 404 of the fold, and the top-right corner 405.

FIG. 5A illustrates schematically example operations 500 of a reference feature prediction model 510 that may be used for processing images of multi-page documents and/or documents having other complex structure, in accordance with some implementations of the present disclosure. Operations of RF prediction model 510 that are performed in training but not in inferencing are depicted with dashed arrows. RF prediction model 510 may be deployed as part of RF detection stage 126 in FIG. 2. RF prediction model 510 may have output multiple RF channels 52n, each RF channel generating an RF probability map pₙ(x, y) for the corresponding corner 40n (using nomenclature of FIG. 4). Although six RF channels 520, 521 . . . 525 are illustrated in FIG. 5A, as an example, the number of RF channels 52n need not be limited.

More specifically, an RF probability map pₙ(x, y) generated by RF channel 52n may represent a heatmap of probabilities for the respective nth corner (or some other reference feature) to be located at a pixel associated with coordinates x, y of image 102. In some implementations, coordinates x, y used in RF probability map pₙ(x, y) may be different (e.g., coarser) than coordinates in the intensity map I(x, y) used as an input into RF prediction model 510. For example, any superpixel x, y of RF probability map pₙ(x, y) may correspond to multiple pixels (e.g., a group 2×2 pixels, 4×4 pixels, etc.) of the intensity map/(x, y). Individual RF probability maps pₙ(x, y) may be normalized, e.g., Σ_{x,y}pₙ(x, y)=1. During inference stage, the predicted locations (coordinates) of RFs may be computed as the expectation values x̅ₙ=Σ_{x,y}x·pₙ(x, y), y̅ₙ=Σ_{x,y}y·pₙ(x, y). In some implementations, the locations of RFs may be computed in some other way, e.g., as coordinates xₘₐₓ>yₘₐₓ where the distribution pₙ(x, y) has a maximum. In some implementations, the locations of RFs may be computed in some other way, e.g., as medians (or some other characteristics, e.g. modes) of the one-dimensional distributions pₙ(x)=Σ_{y}pₙ(x, y) and pₙ(y)=Σₓpₙ(x, y).

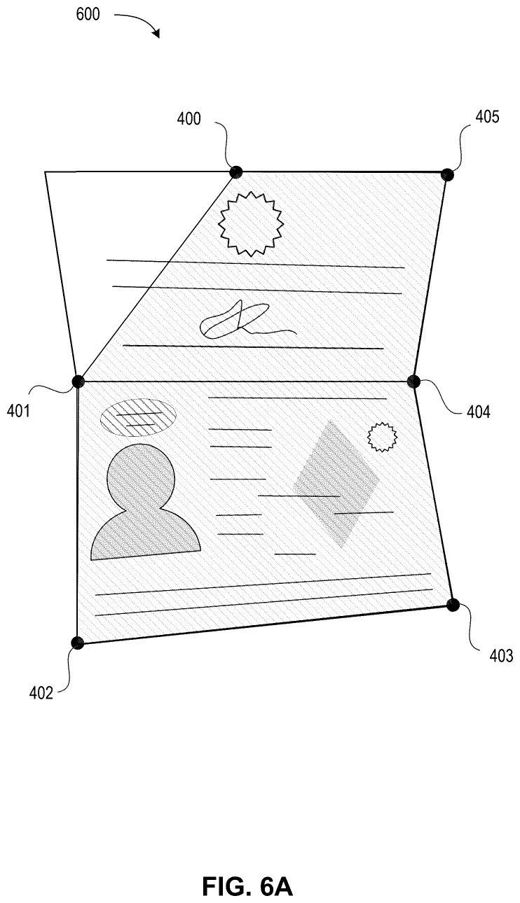

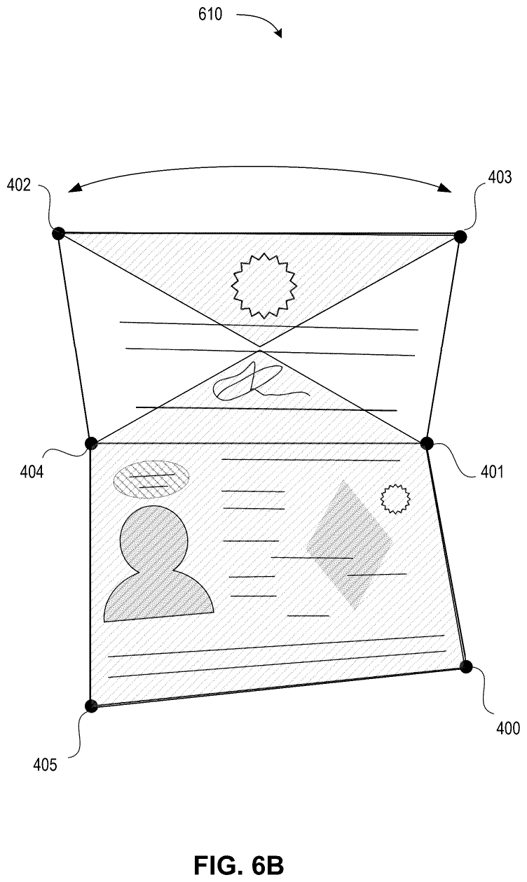

FIG. 5A illustrated schematically an RF probability map p₁(x, y) for top-left corner 401 of a fold of a document and an RF probability map p₅(x, y) for the top-right corner 405 of the same document, which are both single-maxima distributions. In some instances, as illustrated for RF channel 520, a probability map, e.g., an RF probability map p₀(x, y), may be multi-modal with two (or more) maxima corresponding to a combination of a correctly detected top-left corner 401 and an incorrectly mixed top-right corner 405 (which is determined separately by RF channel 525). Computing the expectation value of multi-modal distribution p₀(x, y) would result in an incorrect location of the corresponding RF, e.g., the top-left corner 400 in this example would be determined incorrectly. FIG. 6A illustrated schematically an incorrect prediction 600 of reference features of a document resulting from mixing of multiple reference features in an individual detection channel. As illustrated, the top-left corner 400 is predicted to be at a point that is displaced significantly from its correct location, causing a portion of the document to be undetected. (The detected portion of the document is marked with the shading.)

To eliminate or reduce occurrences of such multi-modal probability maps generated by RF prediction model 510, the predicted probability maps may be handled differently in training and in inference. Referring again to FIG. 2, in some implementations, in inference, Soft-Argmax function may be used to determine an expectation value for each RF probability map 210; in training, Sampling-Argmax function may be used. In training phase, RF probability maps 210 may be handled using distribution sampling 220. More specifically, distribution sampling 220 may randomly sample RF probability maps 210 to select a predicted RF, with the likelihood of sampling a given point x, y determined by the corresponding distribution pₙ(x, y). As a result, locations x, y characterized by higher values of pₙ(x, y) are sampled in a higher number of samplings than the locations characterized by lower values of pₙ(x, y). Locations x, y corresponding to the second (third, etc.) incorrect maximum of the RF probability map(s) 210 are also sampled in the corresponding—determined by pₙ(x, y)—fraction of samplings.

During the training phase, locations of predicted RFs are compared with ground truth RF locations. In some implementations, Sampling-Argmax function determines the relation between predicted RF probability map(s) pₙ(x, y) and the final predicted RF location xᵢ, yᵢ in a differentiable manner via sampling. The distance (e.g., Euclidean distance) dᵢ between a sampled point xᵢ, yᵢ and the ground truth RF may be used as a differentiable loss function whose value is being minimized in training of the RF prediction model 510. Because samplings from incorrectly determined regions of RF probability map(s) 210 are positioned away from the ground truth RF locations, such predictions incur a large cost-quantified by the loss function—the RF detection model learns to output single-maximum distributions within each channel and disfavor RF probability maps 210 with two (or more) maxima. Sampling-Argmax approach may have an advantage over training that uses Soft-Argmax function, which estimates the predicted RF location x, y as an expectation value Σᵢ Softmax(pₙ(xᵢ, yᵢ))·(xᵢ, yᵢ), since Soft-Argmax does not disfavor multi-modal distributions that often cause incorrectly predicted RF locations.

During the inference phase, the RF detection model trained to output single-maximum distributions, RF probability maps 210 may be processed by more economical RF computation 230, which may be performed similarly to Soft-Argmax computations, e.g., by computing the expectation values x̅ₙ and y̅ₙ, maxima, one-dimensional medians or modes, and/or using any other suitable techniques. Such inference processing is faster than probabilistic sampling, especially when performed on low-resource computing devices with large volumes of images to be processed.

In other implementations, the inference processing may also use probabilistic sampling, e.g., when the disclosed techniques are implemented on devices with larger computing and/or memory resources and/or low volume image processing, when processing time is of less concern.

With further reference to FIG. 5A and FIG. 5B, additional improvement of processing efficiency may be achieved by training RF prediction model 510 to predict the set of RFs by all RF channels 52n jointly rather than training a specific RF channel 52n to output a certain reference feature. In particular, permutations of RF detections among RF channels 52n that preserve the topology of the detected document may be accepted while permutations that violate the document topology may be disallowed.

FIG. 5B illustrates various allowed permutations in joint detection of a set of reference features using multiple detection channels, in accordance with some implementations of the present disclosure. Arrangement 530 of the predicted RFs corresponds to the orientation of the RFs in FIG. 4, with RF channels 520 . . . 525 predicting corresponding corners 400 . . . 405 of the document. Acceptable permutation 540 corresponds to a mirror reflection of RF channels 520 . . . 525 in the vertical plane. Permutation 550 is also acceptable because traversing the predicted RF channels 520 . . . 525 in the direction 521-522-523-524-521 encloses one (bottom) page of the document and traversing the predicted RF channels in the direction 524-525-520-521-524 encloses the other (top) page of the document. Similarly, both permutation 550 and permutation 560—obtained from arrangement 530 and permutation 540, respectively, by a mirror reflection of the RF channels in the horizontal plane—are acceptable since the traversal in each of the directions 521-522-523-524-521 and 524-525-520-521-524 encloses a full page of the document. The fact that the top and bottom pages may be swapped or traversed in different (clockwise or counterclockwise) directions is not material since the orientation of each page may be brought to the arrangement 530 based on the coordinates of the predicted RFs, e.g., an RF having the highest (lowest) x and y coordinates may be identified as the top-right (bottom-left) corner of the document regardless of which RF channel outputs these coordinates. Other RFs may be determined using similar rules. The remaining ambiguity with respect to the 90-degree or 180-degree rotations (e.g., as to which page is the bottom page and which page is the top page) may be resolved during subsequent processing, e.g., during the OCR stage.

FIG. 5C illustrates a permutation 565 that is not acceptable, incurs a high cost during training, and is thus learnt to be avoided in training, in accordance with some implementations of the present disclosure. While traversing the predicted RFs in permutation 565 in the direction 524-525-520-521-524 does properly enclose the bottom page of the document, traversing permutation 565 in the direction 521-522-523-524-521 does not enclose the other (top) page of the document (instead cutting across the top page diagonally) and is thus improper. FIG. 6B illustrates schematically an improper detection 610 corresponding to permutation 565 of FIG. 5C of reference feature channels disfavored in training of the reference feature prediction model. (The detected portion of the document is marked with the shading.)

Although in the implementation illustrated in FIG. 5B, RF channels 521 and 524 are shown as detecting the corners of the fold, this is not a requirement and RF channels 521 and 524 may also detect other corners of the document.

With further reference to FIG. 5A, obtained RF probability maps 210 undergo distribution sampling 220 (in training) or RF computation 230 (in inference).To favor acceptable (traversable) permutations and disfavor unacceptable (non-traversable) permutations of RF channels 520 . . . 525, a cyclic (permutational) loss function 570 (with reference to FIG. 5A) may be used in training of RF prediction model 510. For example, a total loss function L_{TOT} for the prediction of RF locations {RFₙ} for a given training image may be computed as,

$${L}_{T O T} = min \{ L ( {\{ R {F}_{n} \}}_{p e r} , \{ {GT}_{n} \} ) \}$$

where {GTₙ}=GT₀, GT₁, . . . stands for the ground truth RFs 580, e.g., correct RF locations, {RFₙ}ₚₑᵣ stands for any acceptable permutation of {RFₙ}=RF₀, RF₁, . . . , e.g., as disclosed above, and L(⋅) represents any suitable loss function that quantifies differences between predicted RF locations and ground truth RF locations, e.g., a sum of squares of Euclidean distances between the corresponding locations (mean square error loss function), or a similar function. In the non-limiting example of FIG. 5A and six RFs, the total loss function may be explicitly computed as,

$${L}_{T O T} = min \{ L ( [ R {F}_{0} , {GT}_{0} ] , [ {RF}_{1} , {GT}_{1} ] , [ {RF}_{2} , {GT}_{2} ] , [ {RF}_{3} , {GT}_{3} ] , [ {RF}_{4} , {GT}_{4} ] , \\ [ {RF}_{5} , {GT}_{5} ] ) ; L ( [ R {F}_{5} , {GT}_{0} ] , [ {RF}_{4} , {GT}_{1} ] , [ {RF}_{3} , {GT}_{2} ] , \\ [ {RF}_{2} , {GT}_{3} ] , [ {RF}_{1} , {GT}_{4} ] , [ {RF}_{0} , {GT}_{5} ] ) L ( [ R {F}_{2} , {GT}_{0} ] , \\ [ {RF}_{1} , {GT}_{1} ] , [ {RF}_{0} , {GT}_{2} ] , [ {RF}_{5} , {GT}_{3} ] , [ {RF}_{4} , {GT}_{4} ] , \\ [ {RF}_{3} , {GT}_{5} ] ) L ( [ R {F}_{3} , {GT}_{0} ] , [ {RF}_{4} , {GT}_{1} ] , [ {RF}_{5} , {GT}_{2} ] , [ {RF}_{0} , {GT}_{3} ] , \\ [ {RF}_{1} , {GT}_{4} ] , [ {RF}_{2} , {GT}_{5} ] ) \} .$$

More specifically, the total loss function selects a minimum computed loss value from various (e.g., four, in this example) acceptable permutations of FIG. 5B. Correspondingly, the acceptably permuted outputs are not penalized in training since there is always one term to be selected by the total loss function that has the smallest error. In contrast, unacceptable permutations (e.g., as the example in FIG. 5C) are not represented in the total loss function and, therefore, none of the terms in L_{TOT} have a small error (loss value). As a result, RF prediction model 510 learns to avoid unacceptable permutations associated with large costs, which are eliminated using various techniques of backpropagation, gradient descent, and/or other learning techniques.

Margins (e.g., margins 304 in FIG. 3B) added to the image (e.g., image 302) facilitate efficient prediction of RFs of documents even in situations where one or more such RFs are not captured by the depictions of documents but are located within the added margins.

Referring again to FIG. 2, RFs predicted by RF computation 230 may be used in RF verification stage 128, which crops the most relevant portion of the image for use in content extraction 250.

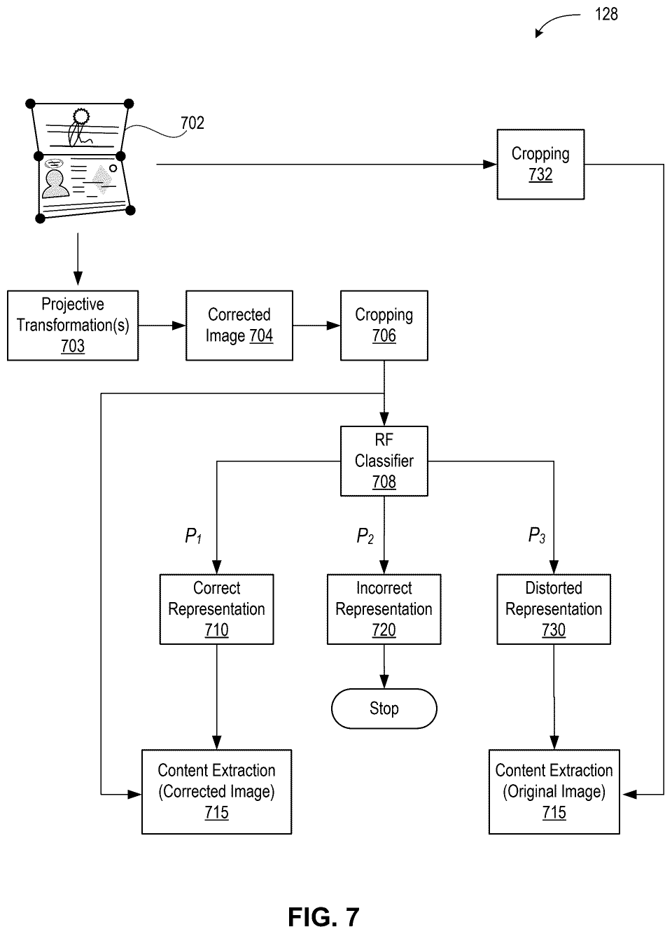

FIG. 7 illustrates operations of reference feature verification stage 128 of processing images of multi-page documents and/or documents having other complex structure, in accordance with some implementations of the present disclosure. An image 702 with predicted RFs (corner points, in this example) may undergo one or more projective transformations 703 to obtain a corrected image 704. Transformation from the (original) image 702 to corrected image 704 may project different pages of the document to a common plane. “Projective transformation” refers to a transformation that maps lines to lines but does not necessarily preserve parallelism. Projective transformations 703 may be used to compensate for perspective distortions that occur when a plane of an imaged object (e.g., document page) is not parallel to an imaging plane of a camera device, being tilted to some angle. Parameters of a projective transformation 703 may be uniquely determined by coordinates of four reference points.

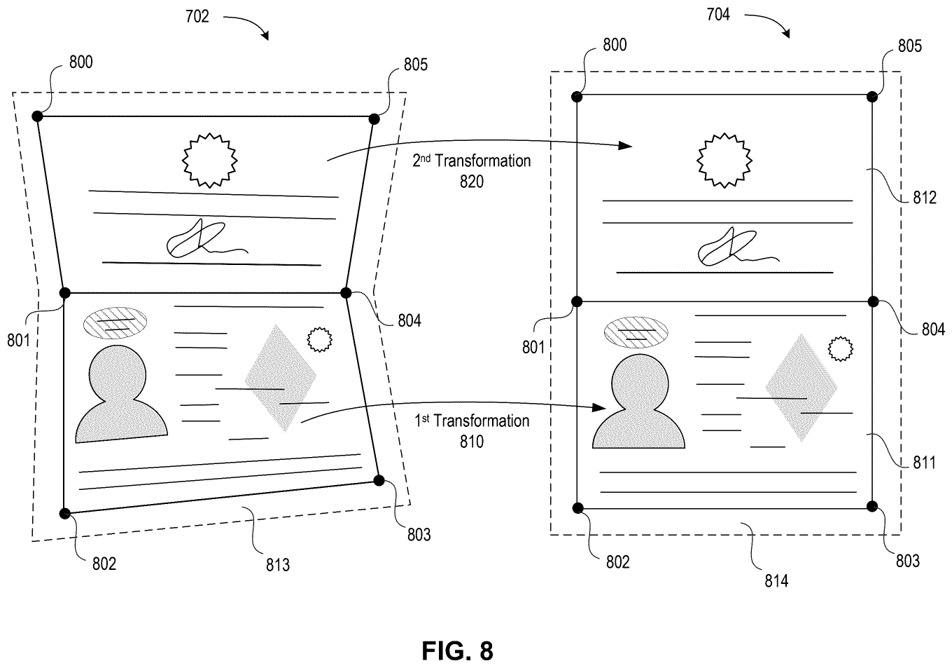

FIG. 8 illustrates schematically projective transformations applied by reference feature verification stage 128 of processing images of multi-page documents and/or documents having other complex structure, in accordance with some implementations of the present disclosure. As illustrated, coordinates of four RFs, e.g., corners 801, 802, 803, and 804 of a first page (e.g., the bottom page) of a two-page document depicted in image 702 may be used to determine parameters of a first transformation 810 that corrects distortions of the first page, e.g., by transforming the first page to a first rectangle 811. Similarly, coordinates of corners 800, 801, 804, and 805 of a second page (e.g., the top page) of the depicted two-page document may be used to determine parameters of a second transformation 820 that corrects distortions of the second page. The second transformation may transform the second page to a second rectangle 812. The first rectangle 811 and the second rectangle 812 may share a line 801-804 that corresponds to the fold of the two-page document. The first rectangle 811 and the second rectangle 812 are parts of corrected image 704. Additionally, a margin portion 814 may be included in corrected image 704. The margin portion 814 may correspond to a certain margin portion 813 of the original image. The margin portion 814 (or margin portion 813) may have dimensions given by a certain (predetermined) fraction of corrected image 704 or (original) image 702. The margin portion 814 adds visual context to the corrected image 704.

Referring again to FIG. 7, corrected image 704 may undergo cropping 706 that crops corrected image 704, e.g., by the outer perimeter of the margin portion 814. The cropped image may be processed by an RF classifier 708 that may be a model trained to classify images of documents by whether such images correctly represent such documents. In some implementations, RF classifier 708 may have three output channels outputting probabilities P₁, P₂, P₃ indicative whether cropped image 704 is a correct representation 710 of the depicted document (probability P₁), an incorrect representation 720 of the depicted document (probability P₂), or a distorted representation 730 of the depicted document (probability P₃). The three probabilities may be normalized, P₁+P₂+P₃=1. RF classifier 708 may classify input images based on their visual appearance. The presence, in the cropped image, of the margin portion 814 depicting a portion of a background may facilitate successful image classification. For example, a depicted document may have different visual characteristics (e.g., color, contrast, etc.) compared with the visual characteristics of the background. Such differences may provide useful context (e.g., delineation of the boundaries of the document) to RF classifier 708.

RF classifier 708 may be trained using training images of multi-page documents that are modified by projective transformations 703, cropped, and classified (e.g., among the three above classes) by a human developer. Training images may be classified to have correct representation 710 of the depicted documents when the RFs defining the cropped portion match (or substantially match, up to minor differences not affecting imaging accuracy) the corresponding features, e.g., corners, of the document. Training images may be classified to have distorted representation 730 of the depicted documents when some of the detected RFs were displaced relative to the corresponding features of the document and that such detection resulted in projective transformations 703 that caused the training image to be detrimentally contorted relative to the original image. Training images may be classified to have incorrect representation 720 of the depicted documents when the detected RFs were significantly misplaced or that the training image is not of a type suitable for the multi-page processing (e.g., when the document is a single-page document or a document of some other type that does not possess correct RFs).

In those instances where probability P₁ is larger than the other probabilities P₂ and P₃ (or larger than a certain empirically set threshold probability PT), RF verification stage 128 may detect a correct representation 710. Correct representation 710 indicates that the corrected image 704 represents a likely improvement over the original image 702. Therefore, content extraction 715 of document content may be performed using the corrected image 704. In some implementations, prior to content extraction 715, the margin portion 814 may be removed from the corrected image 704. In some implementations, the margin portion 814 may be maintained during content extraction 715.

In those instances, where probability P₁ and probability P₃ are less than probability P₂ (or less than some set threshold), RF verification stage 128 may detect an incorrect representation 720. In such instances, processing of image 702 may stop. Incorrect representation 720 may indicate that document type prediction stage 124 (with reference to FIG. 2) may have determined the type of the image incorrectly or that the RF detection stage 126 has incorrectly determined RFs causing misidentification of the document's depiction in the image. For example, such misidentification may mean that a predicted RF is associated with a different document, that the fold line 801-804 has been determined with a large tilt (relative to other edges of the document), and/or that some other error has occurred making further processing of image 702 pointless.

In those instances where probability P₃ is larger than P₁ and P₂, RF verification stage 128 may detect a distorted representation 730. Distorted representation 730 indicates that while the original image 702 depicts a document of a type associated with one or more suitable types, the reference features have been determined with one or more (non-fatal) errors. Distorted representation 730 indicates that the corrected image 704 is likely not an improvement over the (original) image 702. Therefore, the corrected image 704 may be discarded and content extraction 715 may be performed based on the (original) image 702. In some implementations, the (original) image 702 may undergo cropping 732.

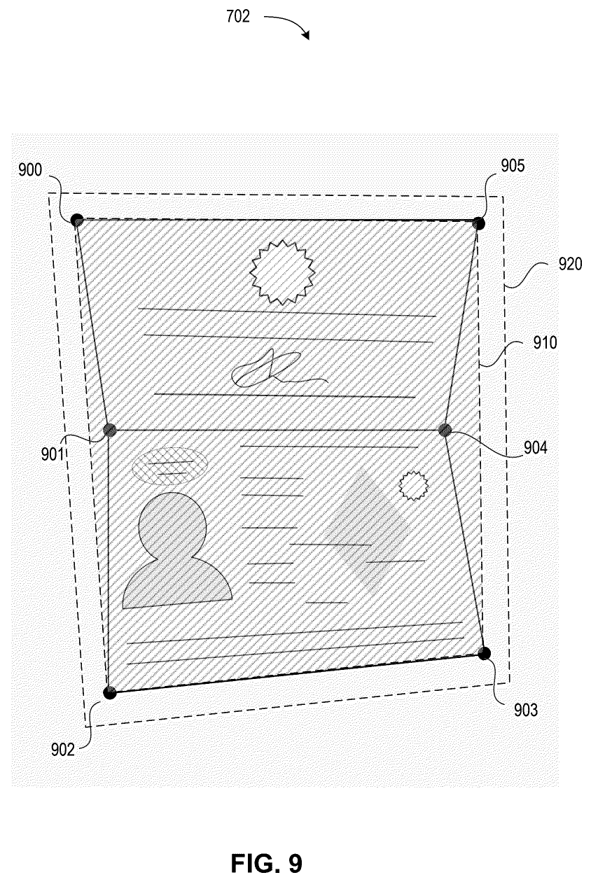

FIG. 9 illustrates one example cropping of an uncorrected image for processing images of multi-page documents and/or documents having other complex structure, in accordance with some implementations of the present disclosure. As illustrated, a bounding quadrilateral 910 may be drawn around a depiction of the document defined by RFs 900-905. (The bounding quadrilateral 910 is also depicted with the shading.) In some implementations, the bounding quadrilateral 910 may be a minimally-sized quadrilateral that fully encloses the depiction of the document. In some implementations, a bounding quadrilateral 920 may be drawn to capture not only the depiction of the document, but also a certain predetermined margin area around the minimal-sized quadrilateral 910. Such enlarged bounding quadrilateral may be used to capture an area of the document that includes an important content but may have been erroneously left outside the minimally-sized bounding quadrilateral 910, e.g., as a result of inaccuracy in the determination of the RFs. Cropping 732 may crop the original image 702 by the bounding quadrilateral 910, bounding quadrilateral 920, or some other suitable figure and use the cropped (original) image 702 for content extraction 715.

Content extraction 715 may include one or more OCR techniques to identify one or more alphanumeric characters in (original) image 702 or corrected image 704, object detection techniques to detect one or more objects of interest in (original) image 702 or corrected image 704, and/or detection of any other suitable content.

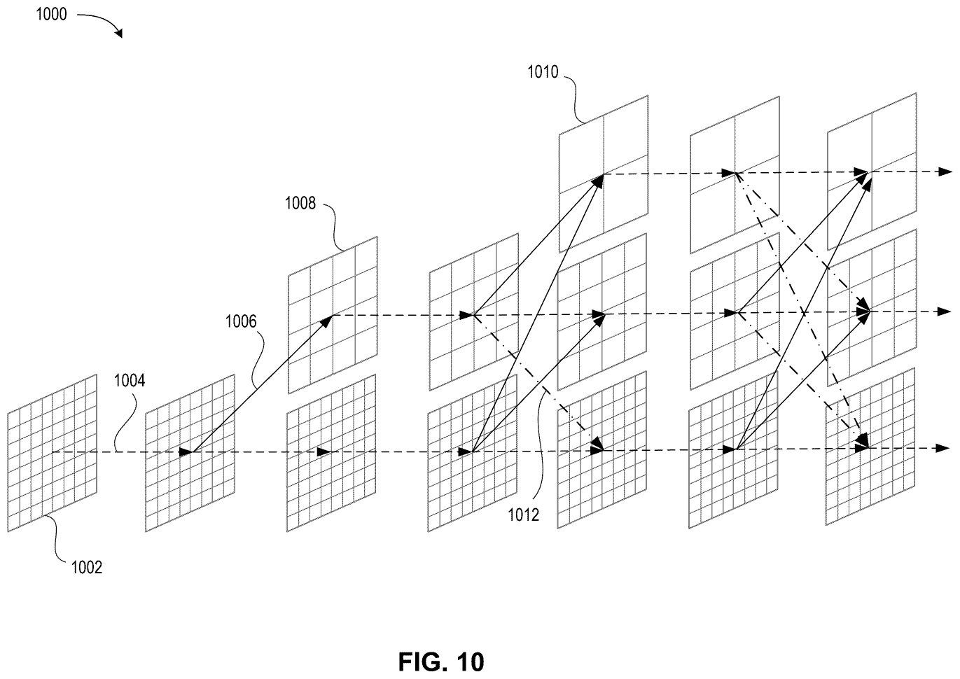

FIG. 10 illustrates schematically an example architecture of a backbone 1000 of a reference feature prediction model that may be used for processing images of multi-page documents and/or documents having other complex structure, in accordance with some implementations of the present disclosure. In some implementations, backbone 1000 may be a part of RF prediction model 510 whose operations are illustrated in FIG. 5A. Backbone 1000 may use a high-resolution feature map 1002 as an input, e.g., with the resolution matching pixel size in an input image, and gradually add more feature maps of other (e.g., reduced) resolutions. More specifically, high-resolution feature map 1002 may be processed with convolution filters 1004 (indicated with dashed arrows), which may include pointwise (e.g., 1×1) convolutions, depthwise (e.g., 3×3, 5×5, etc., with stride 2 and/or any other suitable stride) convolutions, and/or other convolutions. Downsampling filters 1006 (indicated with solid arrows) may be used to generate a reduced-resolution feature map 1008 to initiate a parallel stream of processing with its own set of pointwise and/or depthwise convolutions. Any number of additional reduced-resolution feature maps may be generated, e.g., a feature map 1010 of yet lower resolution (no further feature maps are shown, for conciseness and ease of viewing). During at least some of the neuron layer computations, feature maps of different resolutions may exchange information, e.g., using upsampling filters 1012 (indicated with dot-dashed lines) and downsampling filters 1006. In some implementations, backbone 1000 may be (or include) a Lite-HRNet or other similar networks. The output of backbone 1000 may be used as an input into one or more classification heads (not shown in FIG. 1000) trained to perform semantic segmentation, e.g., generate respective RF probability maps 210 (with reference to FIG. 2 and FIG. 5A).

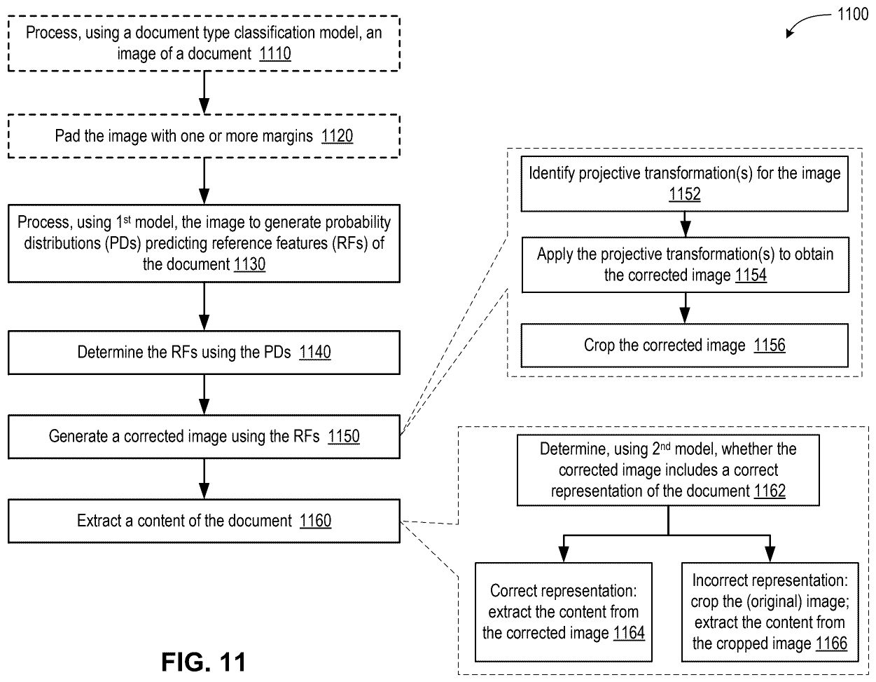

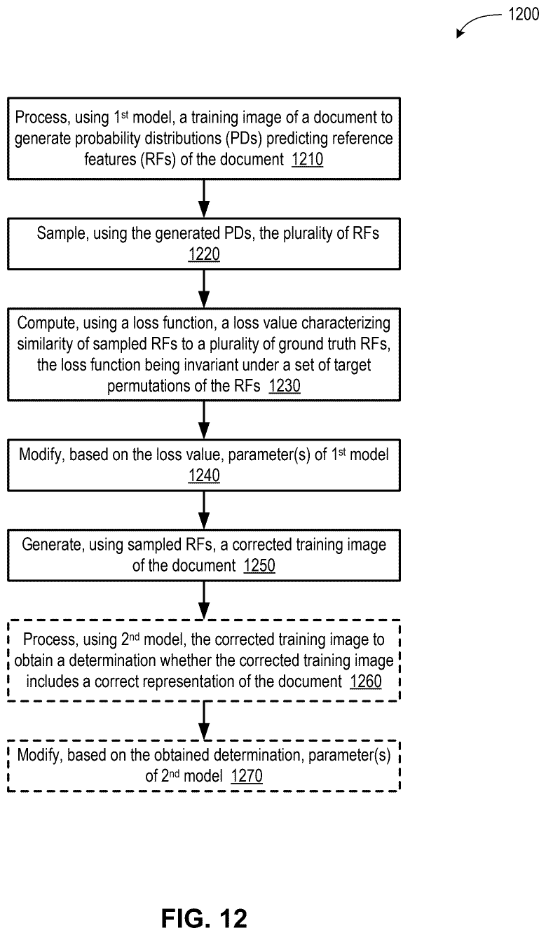

FIGS. 11-12 are flow diagrams illustrating example methods 1100-1200 of deploying machine learning models for processing images of multi-page documents and/or documents having other complex structure, in accordance with some implementations of the present disclosure. A computing device, having one or more processing units (e.g., CPUs, GPUs, PPUs, DPUs, etc.) and memory devices communicatively coupled to the processing units, may perform methods 1100-1200 and/or each of their individual functions, routines, subroutines, or operations. The processing device executing methods 1100-1200 may be (or include) processor 112 of computing device 110 in FIG. 1. In certain implementations, a single processing thread may perform any of methods 1100-1200. Alternatively, two or more processing threads may perform any of methods 1100-1200, each thread executing one or more individual functions, routines, subroutines, or operations of the methods. In an illustrative example, the processing threads implementing any of methods 1100-1200 may be synchronized (e.g., using semaphores, critical sections, and/or other thread synchronization mechanisms). Alternatively, the processing threads implementing any of methods 1100-1200 may be executed asynchronously with respect to each other. Various operations of methods 1100-1200 may be performed in a different order compared with the order shown in FIGS. 11-12. Some operations of methods 1100-1200 may be performed concurrently with other operations. Some operations may be optional.

FIG. 11 is a flow diagram illustrating an example method 1100 of using machine learning models for inference processing of multi-page documents and/or documents having other complex structure, in accordance with some implementations of the present disclosure. In some implementations, method 1100 may include one or more preprocessing operations, e.g., as illustrated with blocks 1110 and 1120. More specifically, at block 1110, method 1100 may include processing, using a document type classification model (e.g., deployed as part of document type prediction stage 124 in FIG. 1), an image of a document to determine a type of the document. Further processing of the image of the document, e.g., using operations of blocks 1130-1160 may be responsive to the type of the document matching a target type (e.g., a multi-page document type). At block 1120, method 1100 may include padding the image with one or more margins (e.g., as disclosed in conjunction with FIGS. 3A-3B).

At block 1130, method 1100 may include processing, using a first model (e.g., RF prediction model 510), an image of a document to generate (e.g., as disclosed in conjunction with FIG. 5A-5C) a plurality of probability distributions (PDs). In some implementations, each PD of the plurality of PDs (e.g., as output by RF channels 520-525) may predict a respective reference feature (RF) of the plurality of RFs of the document. In one example, the plurality of RFs may include one or more corners of the document, one or more edges of the document, and/or the like. In some implementations, the first model may be trained using a first PD-to-RF mapping that maps PDs to RFs by sampling one or more RFs using a plurality of training PDs. The training PDs may be generated for a training image using the first model (e.g., as disclosed in more detail in conjunction with method 1200 of FIG. 12).

At block 1140, method 1100 may include determining the plurality of RFs using the plurality of PDs. In some implementations, an individual PD of the plurality of PDs may be determined using a second PD-to-RF that maps PDs to RFs by determining a corresponding RF the plurality of RFs based on one or more characteristics of the individual PD. For example, the one or more characteristics of the individual PD may include one or more expectation values of the individual PD, one or more median values of the individual PD, one or more mode values of the individual PD, and/or the like.

At block 1150, method 1100 may include generating, using the determined plurality of RFs, a corrected image of the document that corrects one or more distortions in the image of the document. For example, the one or more distortions may include misalignment (tilt) of the document relative to the field of view of a camera that captured the image of the document, a perspective distortion of the image of the document, and/or the like.

In some implementations, generating the corrected image of the document may include operations illustrated with the top callout portion of FIG. 11. More specifically, at block 1152, method 1100 may include identifying, using the determined plurality of RFs, one or more projective transformations for the image of the document. At block 1154, method 1100 may continue with applying the one or more projective transformations to the image of the document to obtain the corrected image of the document. At block 1156, method 1100 may continue with cropping the corrected image of the document, e.g., around the outline of the corrected image of the document, as may be defined by the determined RFs.

At block 1160, method 1100 may continue with extracting, using the corrected image, a content of the document. The extracted content may include letters, numerals, words, phrases, sentences, images, logos, tables, table partitions (e.g., cells, rows, columns, etc.), graphics elements, stamps, signatures, watermarks, and/or any other content that may be present in the document. The content of the document may be extracted using optical character recognition techniques, object detection techniques, vision language models, and/or any other suitable computer vision technique(s).

In some implementations, extracting the content of the document may include operations illustrated with the bottom callout portion of FIG. 11. More specifically, at block 1162, method 1100 may include obtaining, using a second model (e.g., a model of RF verification stage 128), a determination whether the corrected image of the document includes a correct representation of the document. At block 1164, responsive to the determination that the corrected image of the document includes a correct representation, method 1100 may include extracting the content of the document from the corrected image. Alternatively, responsive to the determination, at block 1162, that the corrected image of the document includes a distorted representation of the document, method 1100 may include, at block 1166, cropping the image using the plurality of RFs and extracting the content of the document from the cropped (original) image.

FIG. 12 is a flow diagram illustrating an example method 1200 of training machine learning models for processing images of multi-page documents and/or documents having other complex structure, in accordance with some implementations of the present disclosure. Method 1200 may be performed using one or more processing devices of training server 150. At block 1210, method 1200 may include processing, using a first model (e.g., RF prediction model 510 of FIG. 5A), a training image of a document to generate a plurality of probability distributions (PDs). Each PD of the plurality of PDs may predict a corresponding reference feature (RF) of a plurality of RFs of the document. At block 1220, method 1200 may include sampling (e.g., probabilistically or randomly) the plurality of RFs using the plurality of generated PDs.

At block 1230, method 1200 may include computing, using a loss function, a loss value characterizing similarity of the plurality of sampled RFs to a plurality of ground truth RFs of the document. The ground truth RFs may be annotated by a developer. In some implementations, the loss function may be invariant under a set of target permutations of the plurality of RFs (e.g., permutations illustrated in conjunction with FIG. 5B). At block 1240, method 1200 may include modifying, based on the loss value, one or more parameters of the first model.

In some implementations, method 1200 may include training a second model (e.g., a model of RF verification stage 128). More specifically, at block 1250, method 1200 may include generating, using the plurality of sampled RFs, a corrected training image of the document. The corrected training image may correct one or more distortions (e.g., tilt, perspective distortions, etc.) in the training image of the document. In some implementations, generating the corrected training image of the document may include operations that are similar to operations of block 1150 of method 1100. At block 1260, method 1200 may include processing, using the second model, the corrected training image of the document to obtain a determination whether the corrected training image of the document includes a correct representation of the document. At block 1270, method 1200 may include modifying, based on the obtained determination, one or more parameters of the second model. For example, the parameter(s) of the second model may be modified if the obtained determination does not match a ground truth determination (e.g., developer's annotations).

In some implementations, one or more additional models may be trained as part of method 1200, such as a document type classification model (e.g., a model of the document type prediction stage 124 of FIG. 2). For example, training the document type classification model may include processing the training image of the document to obtain a predicted type of the document and modifying, based on the predicted type of the document and a ground truth type of the document, one or more parameters of the document type classification model. In some implementations, at least one of the predicted type of the document or the ground truth type of the document may include a multi-page document.

FIG. 13 depicts an example computer system 1300 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The example computer system 1300 includes a processing device 1302, a main memory 1304 (e.g., read-only memory (ROM), flash memory, dynamic random-access memory (DRAM) such as synchronous DRAM (SDRAM)), a static memory 1306 (e.g., flash memory, static random access memory (SRAM)), and a data storage device 1318, which communicate with each other via a bus 1330.

Processing device 1302 (which can include processing logic 1303) represents one or more general-purpose processing devices such as a microprocessor, central processing unit, or the like. More particularly, the processing device 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also be one or more special-purpose processing devices such as an application specific integrated circuit (ASIC), a field programmable gate array (FPGA), a digital signal processor (DSP), network processor, or the like. The processing device 1302 is configured to execute instructions 1322 for implementing various modules and components of IPE 120 of FIG. 1 and to perform the operations discussed herein, including operations of method 1200 of training machine learning models and operations of method 1100 of using trained machine learning models for processing of multi-page documents and/or documents having other complex structure.

The computer system 1300 may further include a network interface device 1308. The computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1316 (e.g., a speaker). In one illustrative example, the video display unit 1310, the alphanumeric input device 1312, and the cursor control device 1314 may be combined into a single component or device (e.g., an LCD touch screen).

The data storage device 1318 may include a computer-readable storage medium 1324 on which is stored the instructions 1322 embodying any one or more of the methodologies or functions described herein. The instructions 1322 may also reside, completely or at least partially, within the main memory 1304 and/or within the processing device 1302 during execution thereof by the computer system 1300, the main memory 1304 and the processing device 1302 also constituting computer-readable media. In some implementations, the instructions 1322 may further be transmitted or received over a network 1320 via the network interface device 1308.

While the computer-readable storage medium 1324 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
processing, using a first model, an image of a document to generate a plurality of probability distributions (PDs), each PD of the plurality of PDs predicting a respective reference feature (RF) of a plurality of RFs of the document, wherein the first model is trained using a first PD-to-RF mapping, and wherein the first PD-to-RF mapping samples one or more RFs using a plurality of training PDs generated, using the first model, for a training image;
determining, using the plurality of PDs, the plurality of RFs, wherein an individual PD of the plurality of PDs is determined using a second PD-to-RF mapping, wherein the second PD-to-RF mapping determines a corresponding RF the plurality of RFs based on one or more characteristics of the individual PD;
generating, using the determined plurality of RFs, a corrected image of the document, wherein the corrected image corrects one or more distortions in the image of the document; and
extracting, using the corrected image, a content of the document.

2. The method of claim 1, wherein the document comprises multiple pages.

3. The method of claim 1, wherein the plurality of RFs comprises:
one or more corners of the document; or
one or more edges of the document.

4. The method of claim 1, wherein generating the corrected image of the document comprises:
identifying, using the determined plurality of RFs, one or more projective transformations for the image of the document; and
applying the one or more projective transformations to the image of the document to obtain the corrected image of the document.

5. The method of claim 4, further comprising:
cropping the corrected image of the document, and
extracting the content of the document from the cropped corrected image.

6. The method of claim 1, further comprising:
prior to processing the image of the document using the first model, padding the image with one or more margins.

7. The method of claim 1, further comprising:
processing, using a document type classification model, the image of the document to determine a type of the document, wherein processing the image of the document using the first model is responsive to the type of the document matching a target type.

8. The method of claim 1, wherein the first model is trained using operations comprising:
processing, using the first model, the training image to generate the plurality of training PDs, each training PD of the plurality of training PDs predicting, within the training image, a corresponding RF of the plurality of RFs of a document depicted in the training image;
probabilistically sampling, according to the plurality of generated training PDs, the one or more RFs;
computing, using a loss function, a loss value characterizing similarity of the one or more sampled RFs to one or more ground truth RFs of the document; and
modifying, based on the loss value, one or more parameters of the first model.

9. The method of claim 1, wherein the first model is further trained using a loss function that is invariant under a set of target permutations of the plurality of RFs.

10. The method of claim 1, wherein the one or more characteristics of the individual PD comprise the one or more of:
one or more expectation values of the individual PD,
one or more median values of the individual PD, or
one or more mode values of the individual PD.

11. The method of claim 1, wherein extracting the content of the document comprises:
obtaining, using a second model, a determination that the corrected image of the document comprises a correct representation of the document; and
extracting, responsive to the obtained determination, the content of the document from the corrected image.

12. The method of claim 1, wherein extracting the content of the document comprises:
obtaining, using a second model, a determination that the corrected image of the document comprises a distorted representation of the document;
cropping the image using the plurality of RFs; and
extracting, responsive to the obtained determination, the content of the document from the cropped image.

13. A method comprising:
processing, using a first model, a training image of a document to generate a plurality of probability distributions (PDs), each PD of the plurality of PDs predicting a corresponding reference feature (RF) of a plurality of RFs of the document;
sampling, using the plurality of generated PDs, the plurality of RFs;
computing, using a loss function, a loss value characterizing similarity of the plurality of sampled RFs to a plurality of ground truth RFs of the document, wherein the loss function is invariant under a set of target permutations of the plurality of RFs; and
modifying, based on the loss value, one or more parameters of the first model.

14. The method of claim 13, further comprising:
generating, using the plurality of sampled RFs, a corrected training image of the document, wherein the corrected training image corrects one or more distortions in the training image of the document;
processing, using a second model, the corrected training image of the document to obtain a determination whether the corrected training image of the document comprises a correct representation of the document; and
modifying, based on the obtained determination, one or more parameters of the second model.

15. The method of claim 14, wherein generating the corrected training image of the document comprises:
identifying, using the plurality of sampled RFs, one or more projective transformations for the training image of the document; and
applying the one or more projective transformations to the training image of the document to obtain the corrected training image of the document.

16. The method of claim 13, further comprising:
processing, using a document type classification model, the image of the document to obtain a predicted type of the document; and
modifying, based on the predicted type of the document and a ground truth type of the document, one or more parameters of the document type classification model, wherein at least one of the predicted type of the document or the ground truth type of the document comprises a multi-page document.

17. The method of claim 13, further comprising:
processing, using the first model, an inference image to generate a plurality of inference PDs, each inference PD of the plurality of inference PDs predicting a corresponding RF of the plurality of RFs of an inference document depicted in the inference image;
determining, using the plurality of inference PDs, the plurality of RFs, wherein an individual inference PD of the plurality of inference PDs is determined based on one or more characteristics of the individual inference PD;
generating, using the determined plurality of RFs, a corrected inference image, wherein the corrected inference image corrects one or more distortions in the inference image of the inference document; and
extracting, using the corrected inference image, a content of the inference document.

18. The method of claim 13, wherein the document comprises multiple pages.

19. The method of claim 13, wherein the plurality of RFs comprises:
one or more corners of the document; or
one or more edges of the document.

20. A system comprising:
a memory; and
a processing device communicatively coupled to the memory, the processing device to:
process, using a first model, an image of a document to generate a plurality of probability distributions (PDs), each PD of the plurality of PDs predicting a respective reference feature (RF) of a plurality of RFs of the document, wherein the first model is trained using a first PD-to-RF mapping, and wherein the first PD-to-RF mapping samples one or more RFs using a plurality of training PDs generated, using the first model, for a training image;
determine, using the plurality of PDs, the plurality of RFs, wherein an individual PD of the plurality of PDs is determined using a second PD-to-RF mapping, wherein the second PD-to-RF mapping determines a corresponding RF the plurality of RFs based on one or more characteristics of the individual PD;
generate, using the determined plurality of RFs, a corrected image of the document, wherein the corrected image corrects one or more distortions in the image of the document; and
extract, using the corrected image, a content of the document.
